(19) United States
(12) Patent Application Publication
(10) Pub. No.: US 2026/0269956 A1
(43) Pub. Date: Sep. 10, 2026

(54) INTELLIGENT SCHEDULER FOR SELF-INTERFERENCE MITIGATION

(71) Applicant: T-Mobile USA, Inc., Bellevue, WA (US)

(72) Inventor: William SHVODIAN, McLean, VA (US)

(21) Appl. No.: 19/070,481

(22) Filed: Mar. 4, 2025

(51) Int. Cl. H04B 15/02; H04B 17/309; H04W 52/14; H04W 72/0453

(52) U.S. Cl. CPC H04B 15/02; H04B 17/309; H04W 52/146; H04W 72/0453

(57) ABSTRACT

Solutions are disclosed that reduce self-interference for frequency division duplexing (FDD) communication in wireless networks (i.e., reducing a radio's transmitter interference with its own reception). For cellular communications, as an example, different sets of resource blocks (RBs) used in the uplink (UL) channel produce differing levels of self-interference in the downlink (DL) channel. An intelligent scheduler selects various sets of RBs for user equipment (UE) based on each UE's ability to withstand interference, and awareness of the interference profiles of the various sets of RBs. For example, a UE far from a base station antenna receives a relatively weak signal and yet uses high transmit power. For such a UE, the use of RBs that produce lower levels of interference is more important than it is for UEs closer to the base station that enjoy higher received power while transmitting at lower power levels.

### BACKGROUND

Modern cellular networks, such as fifth generation (5G) cellular networks and likely later generations, employ Frequency Division Duplexing (FDD) in at least some frequency bands. FDD is a communication technique in which uplink (UL) and downlink (DL) communications are transmitted at different frequencies, with a duplex gap separating UL and DL frequencies in order to mitigate interference. UL is user equipment (UE, e.g., cellphone) to base station, and DL is base station to UE. Self-interference occurs when a UE's own UL transmissions interfere with its reception of DL signals from the base station.

Unfortunately, the interference between UL and DL is not entirely eliminated if the UL and DL are relatively close in frequency. The self-interference problem tends to be worse when the UE is near the outer limits of a cell, because the UE's transmission strength tends to be higher (self-interfering signals are more powerful) while the signals received from the base station are lower in power.

### SUMMARY

The following summary is provided to illustrate examples disclosed herein, but is not meant to limit all examples to any particular configuration or sequence of operations.

Solutions are disclosed that provide an intelligent scheduler for self-interference mitigation. Examples monitor, by a base station, for a first user equipment (UE), a first radio signal quality parameter for a downlink (DL) channel and a transmit power for an uplink (UL) channel of a wireless frequency band; monitor, by the base station, for a second UE, a second radio signal quality parameter for the DL channel and a transmit power for the UL channel of the wireless frequency band; and based on at least the first radio signal quality parameter meeting a first radio signal quality performance condition and the second radio signal quality parameter not meeting the first radio signal quality performance condition: assign a first set of resource blocks (RBs) to the first UE for transmission, wherein transmitting the first set of RBs in the UL channel of the wireless frequency band generates a first relative level of interference in the DL channel of the wireless frequency band; and assign a second set of RBs to the second UE for transmission, wherein transmitting the second set of RBs in the UL channel of the wireless frequency band generates a second relative level of interference in the DL channel of the wireless frequency band, wherein the second set of RBs differs from the first set of RBs, and wherein the second relative level of interference is lower than the first relative level of interference.

### BRIEF DESCRIPTION OF THE DRAWINGS

The disclosed examples are described below with reference to the accompanying drawing figures listed below, wherein:

FIG. 1 illustrates an exemplary architecture that advantageously employs an intelligent scheduler for self-interference mitigation;

FIG. 2 illustrates a possible scenario in which the intelligent scheduler of the architecture of FIG. 1 mitigates self-interference;

FIG. 3 illustrates exemplary resource blocks (RBs) that may be used in examples of the architecture of FIG. 1;

FIGS. 4A, 4B, and 4C illustrate exemplary power spectral density plots for various sets of RBs that may be used in examples of the architecture of FIG. 1;

FIG. 5 illustrates further detail for an exemplary intelligent scheduler that may be used in examples of the architecture of FIG. 1;

FIGS. 6, 7, and 8 illustrate flowcharts of exemplary operations associated with the architecture of FIG. 1; and

FIG. 9 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that reduce self-interference for frequency division duplexing (FDD) communication in wireless networks (i.e., reducing a radio's transmitter interference with its own reception). For cellular communications, as an example, different sets of resource blocks (RBs) used in the uplink (UL) channel produce differing levels of self-interference in the downlink (DL) channel. An intelligent scheduler selects various sets of RBs for user equipment (UE) based on each UE's ability to withstand interference, and awareness of the interference profiles of the various sets of RBs. For example, a UE far from a base station antenna receives a relatively weak signal and yet uses high transmit power. For such a UE, the use of RBs that produce lower levels of interference is more important than it is for UEs closer to the base station that enjoy higher received power while transmitting at lower power levels.

Aspects of the disclosure improve the throughput of wireless communications by enabling the use of FDD frequency bands in scenarios in which self-interference would otherwise render the frequency band unusable. Although examples are described primarily for cellular networks, the inventive concepts described herein extend to wireless communications in general. The advantageous operations are accomplished, at least in part, by assigning a second set of RBs to a UE for transmission, wherein transmitting the second set of RBs in the UL channel of the wireless frequency band generates a second relative level of interference in the DL channel of the wireless frequency band, wherein the second set of RBs differs from a first set of RBs, and wherein the second relative level of interference is lower than a first relative level of interference.

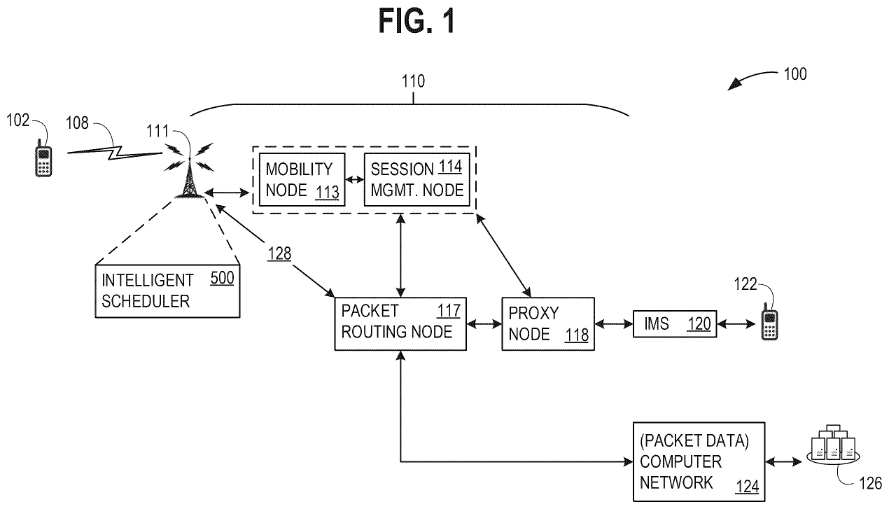

With reference now to the figures, FIG. 1 illustrates an exemplary architecture 100 that advantageously employs an intelligent scheduler 500 for self-interference mitigation. A wireless network 110 is illustrated that is serving a UE 102. UE 102 may be an enhanced mobile broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network.

In the scene depicted in FIG. 1, UE 102 is using wireless network 110 for a packet data session to reach a network resource 126 (e.g., a website) across an external packet data computer network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 108 to communicate with a base station 111 of wireless network 110, such that base station 111 is the serving base station for UE 102 (providing the serving cell). In some scenarios, base station 111 may be referred to as a radio access network (RAN). Wireless network 110 has a mobility node 113, a session management node 114, and other components (not shown). Wireless network 110 also has a packet routing node 117 and a proxy node 118. Mobility node 113 and session management node 114 are within a control plane of wireless network 110, and packet routing node 117 is within a data plane (a.k.a. user plane) of wireless network 110.

Base station 111 is in communication with mobility node 113 and packet routing node 117. Mobility node 113 is in communication with session management node 114, which is in communication with packet routing node 117, and proxy node 118. Packet routing node 117 is in communication with proxy node 118 and computer network 124. In some 5G examples, base station 111 comprises a gNodeB (gNB), mobility node 113 comprises an access mobility function (AMF), session management node 114 comprises a session management function (SMF), and packet routing node 117 comprises a user plane function (UPF). In some 4G examples, base station 111 comprises an eNodeB (eNB), mobility node 113 comprises a mobility management entity (MME), session management node 114 comprises a system architecture evolution gateway (SAEGW) control plane (SAEGW-C), and packet routing node 117 comprises an SAEGW-user plane (SAEGW-U). In some examples, proxy node 118 comprises a proxy call session control function (P-CSCF) in both 4G and 5G.

Proxy node 118 is in communication with an internet protocol (IP) multimedia system (IMS) 120, which uses an access gateway (IMS-AGW) in order to provide connectivity to other wireless (cellular) networks, such as for a call with a UE 122 or a public switched telephone system (PSTN, also known as plain old telephone system, POTS). In some examples, proxy node 118 may be considered to be within IMS 120. UE 102 reaches network resource 126 using computer network 124 (or IMS 120, in some examples). Data packets of data traffic 128 to/from UE 102 pass through at least base station 111 and packet routing node 117 on their way from/to computer network 124 or IMS 120 (via proxy node 118).

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

As illustrated in further detail in the remaining figures, intelligent scheduler 500 reduces self-interference for UEs using wireless network 110. Although FIG. 1 and some of the following figures are described using an example of a cellular network, it should be understood that the teachings herein are applicable to other types of wireless networks. To benefit from the teachings herein, another wireless network, other than a cellular network, should employ FDD communication and an equivalent to resource blocks. With such features, another type of wireless network, other than a cellular network, may also benefit from the disclosure herein.

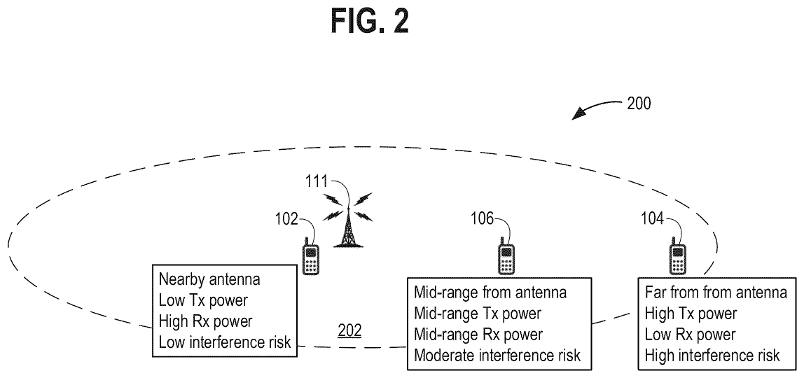

FIG. 2 illustrates a scenario 200 in which base station 111 provides a cell 202 that serves UE 102, a second UE 104, and a third UE 106. UE 102 is nearby base station 111, and so needs only low transmit power, while enjoying relatively high receive power. This creates a low risk of self-interference. UE 104, however is far from base station 111, near the outer edge of cell 202. UE 104 thus requires high transmit power to reach base station 111, and the received signals from base station 111 have relatively low power. This creates a high risk of interference. UE 106 is in the middle, between UE 102 and UE 104, for distance from base station 111, transmit power, receive power, and risk of interference.

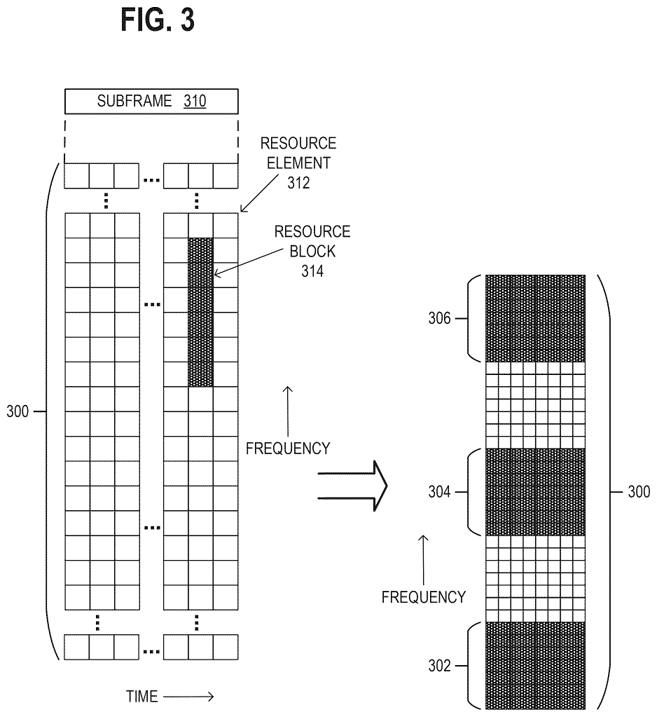

FIG. 3 illustrates exemplary RBs that may be used in a UL channel, in examples of architecture 100. A subframe 310 uses a resource grid 300 composed of resource elements 312, each of which is a symbol transmitted at a particular time and frequency. Resource elements 312 are shown arranged in a grid with dimensions of time and frequency. A collection of resource elements, contiguous in frequency forms a resource block (RB) 314. Resource grid 300 may be segmented into multiple RBs 314 at different frequencies and times.

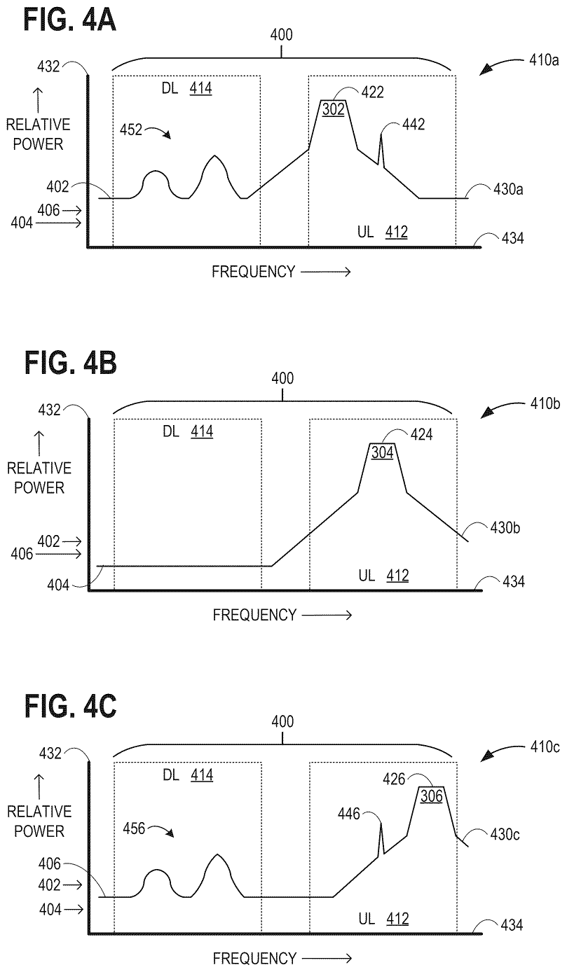

As shown resource grid 300 is segmented into a first set of RBs 302 at the lower end of frequencies, a second set of RBs 304 in the middle range of frequencies, and a third set of RBs 306 at the upper end of the frequencies of resource grid 300. That is, when resource grid 300 is used in a UL channel 412 of a wireless frequency band 400 (as shown in FIG. 4), set of RBs 302 are at lower frequencies than are set of RBs 304, which are at lower frequencies than are set of RBs 306.

FIGS. 4A, 4B, and 4C illustrate exemplary power spectral density plots for various sets of RBs that may be used in examples of architecture 100. FIGS. 4A, 4B, and 4C each show wireless frequency band 400 as FDD, with both UL channel 412 and a DL channel 414, against a relative power axis 432 and a frequency axis 434. In some examples, wireless frequency band 400 may be in the 600 megahertz (MHz) range, with UL channel 412 ranging from 663 MHz to 698 MHz and DL channel 414 ranging from 617 MHz to 652 MHz. In such an example, the frequencies of resource grid 300 span the frequency range of UL channel 412, and UL channel 412 is at a higher frequency than DL channel 414. In some examples, UL channel 412 may be at the lower frequency.

FIG. 4A shows a power spectral density plot 410a for a power spectrum curve 430a, plotted as relative (normalized) power as a function of frequency, for set of RBs 302. Power spectrum curve 430a has a peak 422 that spans the nominal frequencies used for set of RBs 302 in UL channel 412. The position of peak 422 reflects that set of RBs 302 is at the lower end of the frequencies used for UL channel 412, closer to DL channel 414. Unfortunately, power spectrum curve 430a shows that transmission of set of RBs 302 is not entirely clean in the frequency spectrum, but instead spills interference into DL channel 414 at a relative level of interference 402.

A spectral spike 442 is at the center of UL channel 412, and is an artifact of the radio frequency (RF) generation and modulation arrangement in a UE. The offset of peak 422 (due to the frequencies of set of RBs 302) from spectral spike 442 results in a lobing structure 452 in power spectrum curve 430a within the frequencies of DL channel 414. This lobing structure 452 serves to increase the amount of interference power spilled from UL channel 412 into DL channel 414 (i.e., increases relative level of interference 402).

Although relative level of interference 402 is indicated as a certain value, relative to relative power axis 432, is should be understood that relative level of interference 402 is actually the (normalized) cumulative power of the interference received by a UE that is demodulating RBs within DL channel 414, and so more closely resembles an integration of the area under power spectrum curve 430a within DL channel 414, or at least the portion of DL channel 414 in which the UE is demodulating its received RBs—which includes lobing structure 452.

FIG. 4B shows a power spectral density plot 410b for a power spectrum curve 430b, plotted as relative power as a function of frequency, for set of RBs 304. Power spectrum curve 430b has a peak 424 that spans the nominal frequencies used for set of RBs 304 in UL channel 412. The position of peak 424 reflects that set of RBs 304 is at the middle of the frequencies used for UL channel 412. Power spectrum curve 430b shows that transmission of set of RBs 304 spills interference into DL channel 414 at a relative level of interference 404.

Because peak 424 is at the center of center of UL channel 412, any spectral spike that would otherwise occur at the center of UL channel 412, as an artifact of the RF generation and modulation arrangement in a UE is obscured. Since there is no offset of peak 422 (due to the frequencies of set of RBs 304) from a spectral spike, power spectrum curve 430b has a relatively clean roll-off as is passes outside US channel 412, and there is no lobing structure within the frequencies of DL channel 414 that is equivalent to lobing structure 452 of power spectrum curve 430a. This serves to decrease the amount of interference power spilled from UL channel 412 into DL channel 414. Thus, relative level of interference 404 is lower than relative level of interference 402. Ideally, relative level of interference 404 would be zero, but imperfections in RF generation and filtering generally prevent this from being the case.

Although relative level of interference 404 is indicated as a certain value, relative to relative power axis 432, is should be understood that relative level of interference 404 is actually the (normalized) cumulative power of the interference received by a UE that is demodulating RBs within DL channel 414, and so more closely resembles an integration of the area under power spectrum curve 430b within DL channel 414, or at least the portion of DL channel 414 in which the UE is demodulating its received RBs.

FIG. 4C shows a power spectral density plot 410c for a power spectrum curve 430c, plotted as relative power as a function of frequency, for set of RBs 306. Power spectrum curve 430c has a peak 426 that spans the nominal frequencies used for set of RBs 306 in UL channel 412. The position of peak 426 reflects that set of RBs 306 is at the upper end of the frequencies used for UL channel 412, further from DL channel 414. Unfortunately, power spectrum curve 430c shows that transmission of set of RBs 306 is not entirely clean in the frequency spectrum, but instead spills interference into DL channel 414 at a relative level of interference 406.

A spectral spike 446 is at the center of UL channel 412, and is an artifact of the RF generation and modulation arrangement in a UE. The offset of peak 426 (due to the frequencies of set of RBs 306) from spectral spike 446 results in a lobing structure 456 in power spectrum curve 430c within the frequencies of DL channel 414. This lobing structure 456 serves to increase the amount of interference power spilled from UL channel 412 into DL channel 414 (i.e., increases relative level of interference 406).

Although relative level of interference 406 is indicated as a certain value, relative to relative power axis 432, is should be understood that relative level of interference 406 is actually the (normalized) cumulative power of the interference received by a UE that is demodulating RBs within DL channel 414, and so more closely resembles an integration of the area under power spectrum curve 430c within DL channel 414, or at least the portion of DL channel 414 in which the UE is demodulating its received RBs—which includes lobing structure 456.

Power spectrum curves 430a, 430b, and 430c are shown as normalized (relative) power levels because the absolute power is situational, depending on the actual transmission power of the UE's transmitter, which may vary. Thus, the absolute levels of interference also vary based on UE transmit power, and so only relative levels of interference are shown.

For ease of comparison, the relative levels of interference for the other two sets of RBs are annotated on relative power axis 432 in each of FIGS. 4A, 4B, and 4C. For example, power spectral density plot 410a shows relative level of interference 402 as part of power spectrum curve 430a, but is also annotated to also indicate that relative level of interference 402 is higher than either of relative level of interference 406 and relative level of interference 404. Power spectral density plot 410b shows relative level of interference 404 as part of power spectrum curve 430b, but is also annotated to also indicate that relative level of interference 402 is lower than either of relative level of interference 406 and relative level of interference 402. Power spectral density plot 410c shows relative level of interference 406 as part of power spectrum curve 430c, but is also annotated to also indicate that relative level of interference 406 is higher than relative level of interference 404 and lower than relative level of interference 402.

Part of the reason that relative level of interference 402 is higher than relative level of interference 404 might be that the frequencies used in set of RBs 302 is closer to the frequencies used in DL channel 414 than are the frequencies used in set of RBs 304, although this is not necessarily the case. Power spectral densities do not necessarily follow such a simplistic rule, and various harmonics or other issues involved with generation, modulation, filtering, amplification, and transmission of RF energy can significantly complicate transmitted power spectrums.

For example, in the illustrated scenario, relative level of interference 406 is higher than relative level of interference 404, despite the frequencies used in set of RBs 304 being closer to the frequencies used in DL channel 414 than the frequencies used in set of RBs 306. This is because of lobing structure 456, which results from the offset of peak 426 from spectral spike 446, increasing the amount of energy spilled into DL channel 414. This phenomenon is leveraged in some examples of architecture 100, although other examples of architecture 100 may leverage different RF phenomena.

Use of the concepts disclosed herein require merely identifying the relative levels of interference caused by different sets of RBs, rather than resolution of complex RF generation issues that cause such interference. For example, although in this instant example, set of RBs 304 produces the lowest relative level of interference, in some examples, a different set of RBs may instead produce the lowest relative level of interference.

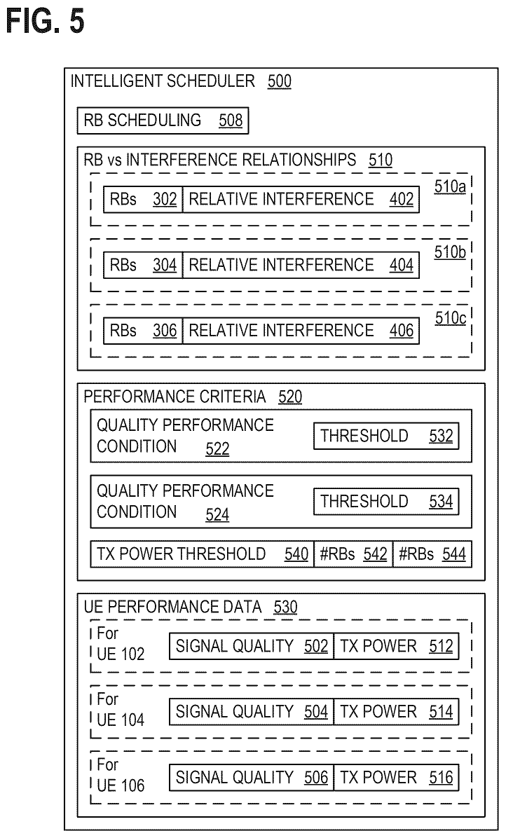

FIG. 5 illustrates further detail for intelligent scheduler 500. Intelligent scheduler 500 has RB scheduling logic 508 that schedules RBs for UEs being served by base station 111, such as based on the amount of data each UE indicates it has in its transmit buffer. However, RB scheduling logic 508 lists the RBs available for scheduling, for each UE, according to the teachings herein, such as by limiting a UE to using set of RBs 304 or set of RBs 306.

Intelligent scheduler 500 has a data set showing relationships 510 between sets of RBs and relative levels of interference, which may have been determined using simulation and/or measurement of various UE RF performance. As shown set of RBs 302 is associated with relative level of interference 402 in a relationship 510a; set of RBs 304 is associated with relative level of interference 404 in a relationship 510b; and set of RBs 306 is associated with relative level of interference 406 in a relationship 510c. Although three relationships between sets of RBs and relative levels of interference are shown, some examples may use a different number.

Intelligent scheduler 500 also has performance criteria 520, which includes a first radio signal quality performance condition 522, which may be a radio signal quality threshold 532, and a second radio signal quality performance condition 524, which may be a radio signal quality threshold 534. Radio signal quality performance condition 522 and radio signal quality performance condition 524 are used to determine when a UE has a sufficiently clean signal quality (such as UE 102) that interference mitigation is a low priority, or whether the UE is in need of interference mitigation (such as UE 104).

Some examples only use a single performance threshold for determining whether interference mitigation is needed. In examples that use two performance thresholds for interference mitigation, however, radio signal quality performance condition 524 is higher than radio signal quality performance condition 522. In this situation, when a UE fails to meet the lower threshold, radio signal quality performance condition 522, the RBs available for that UE to use is restricted to the set of RBs having the lowest level of interference (set of RBs 304, in the example of FIG. 4B).

When a UE meets the lowest threshold, but fails to meet the highest threshold, radio signal quality performance condition 524, the RBs available for that UE to use is restricted to the sets of RBs having the lowest and the second lowest levels of interference (set of RBs 304 and set of RBs 306, in the examples of FIGS. 4B and 4C). When a UE meets the highest threshold, the RBs available for that UE to use are not restricted (i.e., any of set of RBs 302, set of RBs 304, and set of RBs 306 may be used).

Some examples limit set of RBs 304 to maximum number of RBs 542, which may be 20 (or another number). Some examples limit set of RBs 306 to maximum number of RBs 542 (or another number), and some examples also limit set of RBs 302 to maximum number of RBs 542. In some examples, when a UE's transmit power exceeds a transmit power threshold 540, set of RBs 304 is further limited to maximum number of RBs 544, which is lower, such as 10 or 15 (or another number).

Some examples only apply maximum number of RBs 544 to set of RBs 304, because the first tier of interference reduction is using set of RBs 304, and only after set of RBs 304 is being used will maximum number of RBs 542 be reduced to maximum number of RBs 544. Some examples my also apply maximum number of RBs 544 to set of RBs 306 and even some to set of RBs 302.

Intelligent scheduler 500 also has UE performance data 530, which includes a radio signal quality parameter 502 and a transmit power 512 for UE 102, a radio signal quality parameter 504 and a transmit power 514 for UE 104, and a radio signal quality parameter 506 and a transmit power 516 for UE 106. Transmit power 512, transmit power 514, and transmit power 516 may be determined using UL power headroom values, which is reported in a power headroom report (PHR) by each of UEs 102-106. Radio signal quality parameters 502, 504, and 506 are for DL channel 414, as received by each of UEs 102-106, and may be any of (or a combination of any of): block error rate (BLER), channel state information (CSI), received signal strength indicator (RSSI), reference signal receive power (RSRP), reference signal received quality (RSRQ), and signal to interference plus noise ratio (SINR).

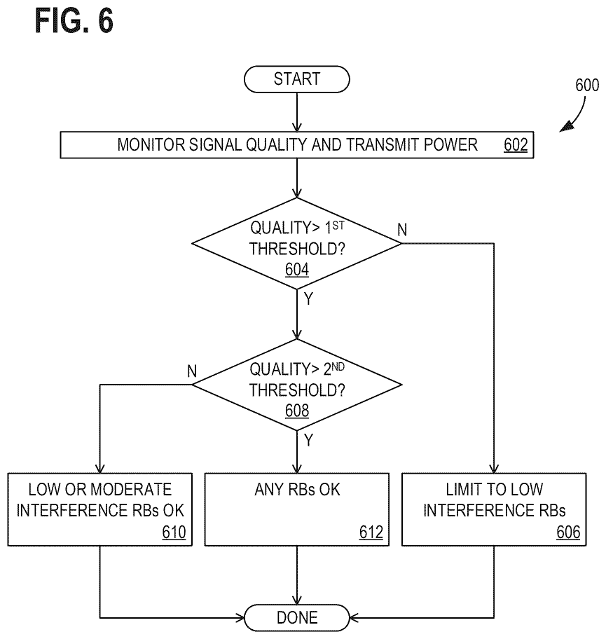

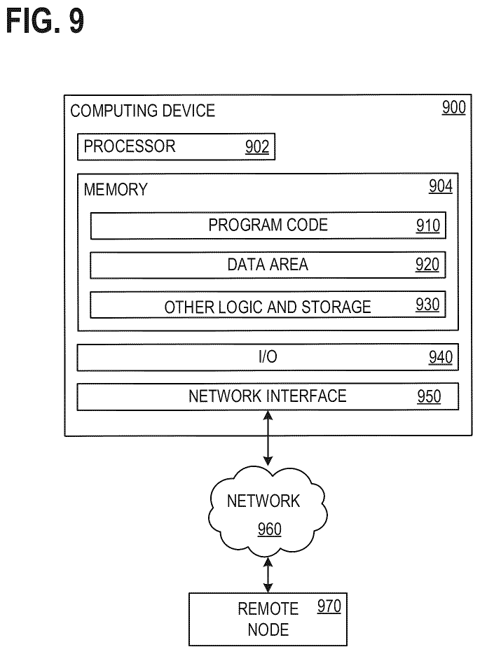

FIG. 6 illustrates a flowchart 600 of exemplary operations associated with examples of architecture 100. In some examples, at least a portion of flowchart 600 may be performed using one or more computing devices 900 of FIG. 9. Flowchart 600 shows the logic for selecting from among sets of RBs 302-306 for each of UEs 102-106, using radio signal quality parameters 502-506. Flowchart 600 commences with monitoring signal quality and transmit power for a UE, in operation 602. For example, intelligent scheduler 500 monitors radio signal quality parameter 502 and transmit power 512 for UE 102, radio signal quality parameter 504 and transmit power 514 for UE 104, and radio signal quality parameter 506 and transmit power 516 for UE 106.

Decision operation 604 determines whether the radio signal quality parameter for a UE meets radio signal quality performance condition 522 (e.g., meets radio signal quality threshold 532). If not, operation 606 limits that UE to using only set of RBs 304. This is the situation for UE 104.

Otherwise, if the radio signal quality parameter for a UE meets radio signal quality performance condition 522, decision operation 608 determines whether the radio signal quality parameter for the UE meets radio signal quality performance condition 524 (e.g., meets radio signal quality threshold 534). If not, operation 610 limits that UE to using either set of RBs 304 or set of RBs 306. This is the situation for UE 106. That is, UE 106 is permitted to use set of RBs 306. In some situations, UE 106 may be assigned RBs that include (or are limited to) set of RBs 304. This may occur based on network traffic conditions and whether set of RBs 306 have been assigned to another UE for use, and so are just not available for UE 106.

However, if the radio signal quality parameter for a UE meets radio signal quality performance condition 524, operation 612 permits that UE to use any of set of RBs 302-306. This is the situation for UE 102. That is, UE 102 is permitted to use set of RBs 302. In some situations, UE 106 may be assigned RBs that include (or are limited to) set of RBs 304 and/or set of RBs 306. This may occur based on network traffic conditions and whether set of RBs 302 have been assigned to another UE for use, and so are just not available for UE 102. Or, perhaps UE 102 uses a large number of RBs, including RBs in set of RBs 302 and also in sets of RBs 304 and 306.

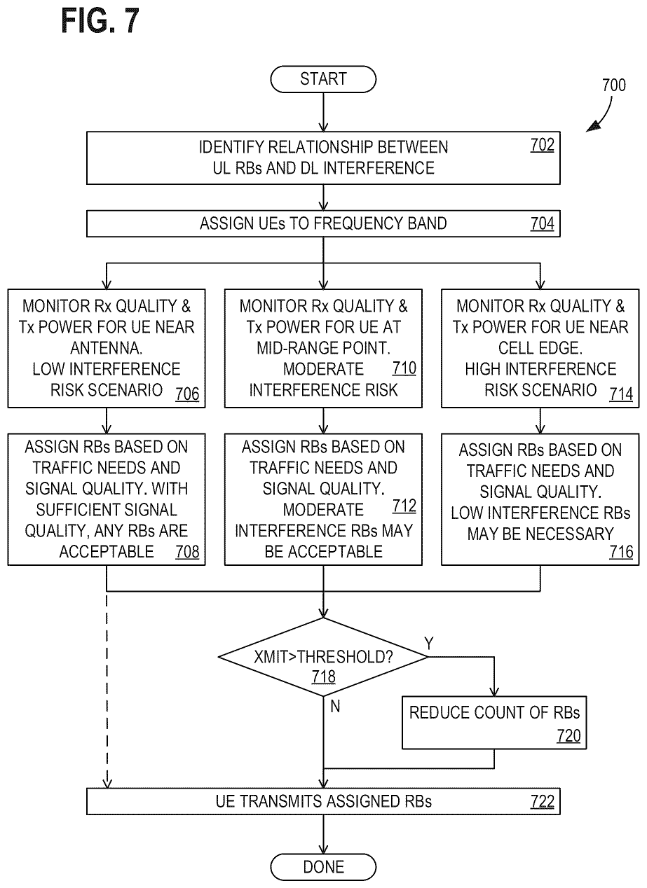

FIG. 7 illustrates a flowchart 700 of exemplary operations associated with examples of architecture 100, specifically, the application of flowchart 600 (of FIG. 6) to scenario 200 (of FIG. 2). In some examples, at least a portion of flowchart 700 may be performed using one or more computing devices 900 of FIG. 9. Flowchart 700 commences with identifying relationships 510 between sets of RBs 302-306 and relative levels of interference 402-406 in DL channel 414 of wireless frequency band 400, in operation 702.

In operation 704, base station 111 assigns UE 102, UE 104, and UE 106 to wireless frequency band 400, creating scenario 200. Flowchart 700 splits into three branches, one for UE 102, another for UE 106, and the third for UE 104.

Base station 111 monitors radio signal quality parameter 502 (for DL channel 414) and transmit power 512 for UE 102 in operation 706. In operation 708, based on at least radio signal quality parameter 502 meeting radio signal quality performance condition 522, and further based on at least radio signal quality parameter 502 meeting radio signal quality performance condition 524, intelligent scheduler assigns set of RBs 302 to UE 102 for transmission. This is because, even though relative level of interference 402 is the highest level of interference, the low interference situation for UE 102 makes this acceptable (i.e. the SINR for UE 102 is within a tolerable range).

In some examples, set of RBs 302 is limited by maximum number of RBs 542. In some examples, flowchart 700 moves directly from operation 708 to operation 722, bypassing decision operation 718 for UE 102. This is because, if UE 102 has sufficient signal quality to use set of RBs 302, there is no need to limit set of RBs 302 by maximum number of RBs 544. In some examples, though, flowchart 700 does move from operation 708 to decision operation 718 for UE 102.

Base station 111 monitors radio signal quality parameter 506 (for DL channel 414) and transmit power 514 for UE 106 in operation 710. In operation 712, based on at least radio signal quality parameter 506 meeting radio signal quality performance condition 522, and further based on at least radio signal quality parameter 506 not meeting radio signal quality performance condition 524, intelligent scheduler assigns set of RBs 306 to UE 106 for transmission. This is because, even though relative level of interference 406 is a moderate level of interference, the interference situation for UE 106 makes this acceptable (i.e. the SINR for UE 106 is still within a tolerable range).

In some examples, set of RBs 306 is limited by maximum number of RBs 542. In some examples, flowchart 700 moves directly from operation 712 to operation 722, bypassing decision operation 718 for UE 106. This is because, if UE 106 has sufficient signal quality to use set of RBs 306, there is no need to limit set of RBs 306 by maximum number of RBs 544. In some examples, though, flowchart 700 does move from operation 712 to decision operation 718 for UE 106.

Base station 111 monitors radio signal quality parameter 504 (for DL channel 414) and transmit power 512 for UE 104 in operation 714. In operation 716, based on at least radio signal quality parameter 504 not meeting radio signal quality performance condition 522, intelligent scheduler assigns set of RBs 304 to UE 104 for transmission. This is because relative level of interference 404 is the lowest level of interference, and the interference situation for UE 104 may require level of interference 404 in order to put the SINR for UE 104 into a tolerable range.

Set of RBs 306 is limited by maximum number of RBs 542. If decision operation 718 determines that transmit power 514 of UE 104 meets transmit power threshold 540, set of RBs 304 is limited to maximum number of RBs 544 in operation 720. In examples that perform decision operation 718 for UE 106, if transmit power 516 of UE 106 meets transmit power threshold 540, set of RBs 306 is limited to maximum number of RBs 544 (or another reduced count of RBs). In examples that perform decision operation 718 for UE 102, if transmit power 512 of UE 102 meets transmit power threshold 540, set of RBs 302 is limited to maximum number of RBs 544 (or another reduced count of RBs). Each UE transmits data using its assigned set of RBs, in operation 722.

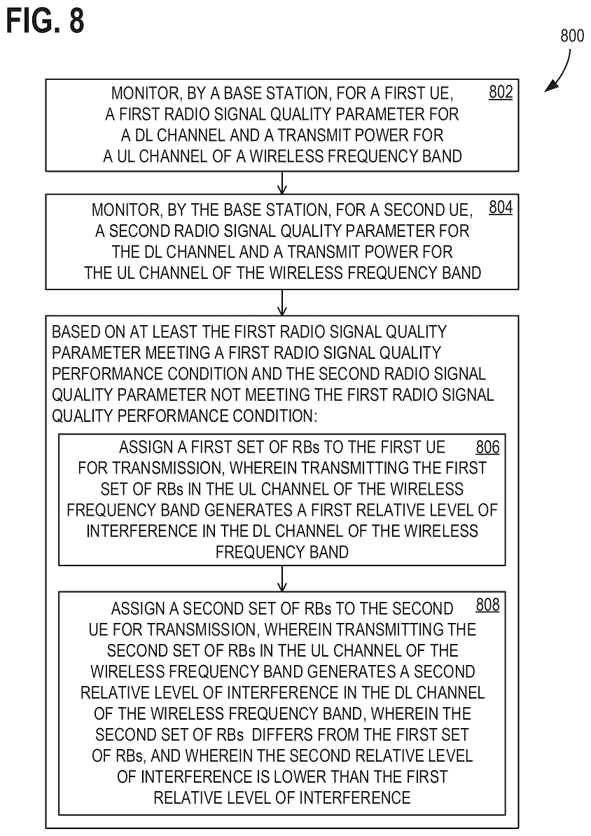

FIG. 8 illustrates a flowchart 800 of exemplary operations associated with architecture 100. In some examples, at least a portion of flowchart 800 may be performed using one or more computing devices 900 of FIG. 9. Flowchart 800 commences with operation 802, which includes monitoring, by a base station, for a first UE, a first radio signal quality parameter for a DL channel and a transmit power for a UL channel of a wireless frequency band. Operation 804 includes monitoring, by the base station, for a second UE, a second radio signal quality parameter for the DL channel and a transmit power for the UL channel of the wireless frequency band.

Operations 806 and 808 are each based on at least the first radio signal quality parameter meeting a first radio signal quality performance condition and the second radio signal quality parameter not meeting the first radio signal quality performance condition. Operation 806 includes assigning a first set of RBs to the first UE for transmission, wherein transmitting the first set of RBs in the UL channel of the wireless frequency band generates a first relative level of interference in the DL channel of the wireless frequency band. Operation 808 includes assigning a second set of RBs to the second UE for transmission, wherein transmitting the second set of RBs in the UL channel of the wireless frequency band generates a second relative level of interference in the DL channel of the wireless frequency band, wherein the second set of RBs differs from the first set of RBs, and wherein the second relative level of interference is lower than the first relative level of interference.

FIG. 9 illustrates a block diagram of computing device 900 that may be used as any component described herein that may require computational or storage capacity. Computing device 900 has at least a processor 902 and a memory 904 that holds program code 910, data area 920, and other logic and storage 930. Memory 904 is any device allowing information, such as computer executable instructions and/or other data, to be stored and retrieved. For example, memory 904 may include one or more random access memory (RAM) modules, flash memory modules, hard disks, solid-state disks, persistent memory devices, and/or optical disks. Program code 910 comprises computer executable instructions and computer executable components including instructions used to perform operations described herein. Data area 920 holds data used to perform operations described herein. Memory 904 also includes other logic and storage 930 that performs or facilitates other functions disclosed herein or otherwise required of computing device 900. An input/output (I/O) component 940 facilitates receiving input from users and other devices and generating displays for users and outputs for other devices. A network interface 950 permits communication over external computer network 960 (e.g., computer network 124) with a remote node 970, which may represent another implementation of computing device 900. For example, a remote node 970 may represent another of the above-noted nodes within architecture 100.

### ADDITIONAL EXAMPLES

An example system comprises: a processor; and a computer-readable medium storing instructions that are operative upon execution by the processor to: monitor, by a base station, for a first UE, a first radio signal quality parameter for a DL channel and a transmit power for a UL channel of a wireless frequency band; monitor, by the base station, for a second UE, a second radio signal quality parameter for the DL channel and a transmit power for the UL channel of the wireless frequency band; and based on at least the first radio signal quality parameter meeting a first radio signal quality performance condition and the second radio signal quality parameter not meeting the first radio signal quality performance condition: assign a first set of RBs to the first UE for transmission, wherein transmitting the first set of RBs in the UL channel of the wireless frequency band generates a first relative level of interference in the DL channel of the wireless frequency band; and assign a second set of RBs to the second UE for transmission, wherein transmitting the second set of RBs in the UL channel of the wireless frequency band generates a second relative level of interference in the DL channel of the wireless frequency band, wherein the second set of RBs differs from the first set of RBs, and wherein the second relative level of interference is lower than the first relative level of interference.

An example method of wireless communication comprises: monitoring, by a base station, for a first UE, a first radio signal quality parameter for a DL channel and a transmit power for a UL channel of a wireless frequency band; monitoring, by the base station, for a second UE, a second radio signal quality parameter for the DL channel and a transmit power for the UL channel of the wireless frequency band; and based on at least the first radio signal quality parameter meeting a first radio signal quality performance condition and the second radio signal quality parameter not meeting the first radio signal quality performance condition: assigning a first set of RBs to the first UE for transmission, wherein transmitting the first set of RBs in the UL channel of the wireless frequency band generates a first relative level of interference in the DL channel of the wireless frequency band; and assigning a second set of RBs to the second UE for transmission, wherein transmitting the second set of RBs in the UL channel of the wireless frequency band generates a second relative level of interference in the DL channel of the wireless frequency band, wherein the second set of RBs differs from the first set of RBs, and wherein the second relative level of interference is lower than the first relative level of interference.

One or more example computer storage devices has computer-executable instructions stored thereon, which, upon execution by a computer, cause the computer to perform operations comprising: monitoring, by a base station, for a first UE, a first radio signal quality parameter for a DL channel and a transmit power for a UL channel of a wireless frequency band; monitoring, by the base station, for a second UE, a second radio signal quality parameter for the DL channel and a transmit power for the UL channel of the wireless frequency band; and based on at least the first radio signal quality parameter meeting a first radio signal quality performance condition and the second radio signal quality parameter not meeting the first radio signal quality performance condition: assigning a first set of RBs to the first UE for transmission, wherein transmitting the first set of RBs in the UL channel of the wireless frequency band generates a first relative level of interference in the DL channel of the wireless frequency band; and assigning a second set of RBs to the second UE for transmission, wherein transmitting the second set of RBs in the UL channel of the wireless frequency band generates a second relative level of interference in the DL channel of the wireless frequency band, wherein the second set of RBs differs from the first set of RBs, and wherein the second relative level of interference is lower than the first relative level of interference.

Alternatively, or in addition to the other examples described herein, examples include any combination of the following:
the wireless network comprises a cellular network;
the UE comprises a cellular phone, an eMBB, an FWA device, or a computer with a cellular modem;
the first radio signal quality parameter further meets a second radio signal quality performance condition;
monitoring, by the base station, for a third UE, a third radio signal quality parameter for the DL channel and a transmit power for the UL channel of the wireless frequency band;
based on at least the third radio signal quality parameter meeting the first radio signal quality performance condition but not meeting the second radio signal quality performance condition: assigning a third set of RBs to the third UE for transmission, wherein transmitting the third set of RBs in the UL channel of the wireless frequency band generates a third relative level of interference in the DL channel of the wireless frequency band, wherein the third set of RBs differs from both the first set of RBs and the second set of RBs, and wherein the third relative level of interference is lower than the first relative level of interference and higher than the second relative level of interference;
the UL channel of the wireless frequency band is at a higher or lower frequency than the DL channel of the wireless frequency band;
the first set of RBs are at frequencies in the UL channel which are closer to the DL channel of the wireless frequency band than are the second set of RBs;
the second set of RBs are at frequencies in the UL channel which are closer to the DL channel of the wireless frequency band than are the third set of RBs;
the first radio signal quality parameter and the second radio signal quality parameter each comprises at least one parameter selected from the list consisting of: BLER, CSI, RSSI, RSRP, RSRQ, and SINR;
the second set of RBs is limited by a first maximum number of RBs;
based on at least determining that a transmit power of the second UE meets a transmit power threshold, limiting the second set of RBs to a second maximum number of RBs lower than the first maximum number of RBs;
the first maximum number of RBs is 20;
assigning, by the base station, the first UE, the second UE, and the third UE to the wireless frequency band;
the base station is a base station of a cellular network;
the wireless frequency band is an FDD band of a cellular network;
determining that the transmit power of the second UE meets the transmit power threshold;
the first radio signal quality performance condition comprises a first radio signal quality threshold;
the second radio signal quality performance condition comprises a second radio signal quality threshold;
the first set of RBs is limited by the first maximum number of RBs; and
the third set of RBs is limited by the first maximum number of RBs.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
monitoring, by a base station, for a first user equipment (UE), a first radio signal quality parameter for a downlink (DL) channel and a transmit power for an uplink (UL) channel of a wireless frequency band;
monitoring, by the base station, for a second UE, a second radio signal quality parameter for the DL channel and a transmit power for the UL channel of the wireless frequency band; and
based on at least the first radio signal quality parameter meeting a first radio signal quality performance condition and the second radio signal quality parameter not meeting the first radio signal quality performance condition:
assigning a first set of resource blocks (RBs) to the first UE for transmission, wherein transmitting the first set of RBs in the UL channel of the wireless frequency band generates a first relative level of interference in the DL channel of the wireless frequency band; and
assigning a second set of RBs to the second UE for transmission, wherein transmitting the second set of RBs in the UL channel of the wireless frequency band generates a second relative level of interference in the DL channel of the wireless frequency band, wherein the second set of RBs differs from the first set of RBs, and wherein the second relative level of interference is lower than the first relative level of interference.

2. The method of claim 1, wherein the first radio signal quality parameter further meets a second radio signal quality performance condition, and wherein the method further comprises:
monitoring, by the base station, for a third UE, a third radio signal quality parameter for the DL channel and a transmit power for the UL channel of the wireless frequency band; and
based on at least the third radio signal quality parameter meeting the first radio signal quality performance condition but not meeting the second radio signal quality performance condition:
assigning a third set of RBs to the third UE for transmission, wherein transmitting the third set of RBs in the UL channel of the wireless frequency band generates a third relative level of interference in the DL channel of the wireless frequency band, wherein the third set of RBs differs from both the first set of RBs and the second set of RBs, and wherein the third relative level of interference is lower than the first relative level of interference and higher than the second relative level of interference.

3. The method of claim 2,
wherein the UL channel of the wireless frequency band is at a higher or lower frequency than the DL channel of the wireless frequency band;
wherein the first set of RBs are at frequencies in the UL channel which are closer to the DL channel of the wireless frequency band than are the second set of RBs; and
wherein the second set of RBs are at frequencies in the UL channel which are closer to the DL channel of the wireless frequency band than are the third set of RBs.

4. The method of claim 1, wherein the first radio signal quality parameter and the second radio signal quality parameter each comprises at least one parameter selected from the list consisting of:
block error rate (BLER), channel state information (CSI), received signal strength indicator (RSSI), reference signal receive power (RSRP), reference signal received quality (RSRQ), and signal to interference plus noise ratio (SINR).

5. The method of claim 1, wherein the second set of RBs is limited by a first maximum number of RBs.

6. The method of claim 5, further comprising:
based on at least determining that a transmit power of the second UE meets a transmit power threshold, limiting the second set of RBs to a second maximum number of RBs lower than the first maximum number of RBs.

7. The method of claim 5, wherein the first maximum number of RBs is 20.

8. A system comprising:
a processor; and
a computer-readable medium storing instructions that are operative upon execution by the processor to:
monitor, by a base station, for a first user equipment (UE), a first radio signal quality parameter for a downlink (DL) channel and a transmit power for an uplink (UL) channel of a wireless frequency band;
monitor, by the base station, for a second UE, a second radio signal quality parameter for the DL channel and a transmit power for the UL channel of the wireless frequency band; and
based on at least the first radio signal quality parameter meeting a first radio signal quality performance condition and the second radio signal quality parameter not meeting the first radio signal quality performance condition:
assign a first set of resource blocks (RBs) to the first UE for transmission, wherein transmitting the first set of RBs in the UL channel of the wireless frequency band generates a first relative level of interference in the DL channel of the wireless frequency band; and
assign a second set of RBs to the second UE for transmission, wherein transmitting the second set of RBs in the UL channel of the wireless frequency band generates a second relative level of interference in the DL channel of the wireless frequency band, wherein the second set of RBs differs from the first set of RBs, and wherein the second relative level of interference is lower than the first relative level of interference.

9. The system of claim 8, wherein the first radio signal quality parameter further meets a second radio signal quality performance condition, and wherein the instructions are further operative to:
monitor, by the base station, for a third UE, a third radio signal quality parameter for the DL channel and a transmit power for the UL channel of the wireless frequency band; and
based on at least the third radio signal quality parameter meeting the first radio signal quality performance condition but not meeting the second radio signal quality performance condition:
assign a third set of RBs to the third UE for transmission, wherein transmitting the third set of RBs in the UL channel of the wireless frequency band generates a third relative level of interference in the DL channel of the wireless frequency band, wherein the third set of RBs differs from both the first set of RBs and the second set of RBs, and wherein the third relative level of interference is lower than the first relative level of interference and higher than the second relative level of interference.

10. The system of claim 9,
wherein the UL channel of the wireless frequency band is at a higher or lower frequency than the DL channel of the wireless frequency band;
wherein the first set of RBs are at frequencies in the UL channel which are closer to the DL channel of the wireless frequency band than are the second set of RBs; and
wherein the second set of RBs are at frequencies in the UL channel which are closer to the DL channel of the wireless frequency band than are the third set of RBs.

11. The system of claim 8, wherein the first radio signal quality parameter and the second radio signal quality parameter each comprises at least one parameter selected from the list consisting of:
block error rate (BLER), channel state information (CSI), received signal strength indicator (RSSI), reference signal receive power (RSRP), reference signal received quality (RSRQ), and signal to interference plus noise ratio (SINR).

12. The system of claim 8, wherein the second set of RBs is limited by a first maximum number of RBs.

13. The system of claim 12, wherein the instructions are further operative to:
based on at least determining that a transmit power of the second UE meets a transmit power threshold, limit the second set of RBs to a second maximum number of RBs lower than the first maximum number of RBs.

14. The system of claim 12, wherein the first maximum number of RBs is 20.

15. One or more computer storage devices having computer-executable instructions stored thereon, which, upon execution by a computer, cause the computer to perform operations comprising:
monitoring, by a base station, for a first user equipment (UE), a first radio signal quality parameter for a downlink (DL) channel and a transmit power of an uplink (UL) channel of a wireless frequency band;
monitoring, by the base station, for a second UE, a second radio signal quality parameter for the downlink (DL) channel and a transmit power of the UL channel of the wireless frequency band; and
based on at least the first radio signal quality parameter meeting a first radio signal quality performance condition and the second radio signal quality parameter not meeting the first radio signal quality performance condition:
assigning a first set of resource blocks (RBs) to the first UE for transmission, wherein transmitting the first set of RBs in the UL channel of the wireless frequency band generates a first relative level of interference in the DL channel of the wireless frequency band; and
assigning a second set of RBs to the second UE for transmission, wherein transmitting the second set of RBs in the UL channel of the wireless frequency band generates a second relative level of interference in the DL channel of the wireless frequency band, wherein the second set of RBs differs from the first set of RBs, and wherein the second relative level of interference is lower than the first relative level of interference.

16. The one or more computer storage devices of claim 15, wherein the first radio signal quality parameter further meets a second radio signal quality performance condition, and wherein the operations further comprise:
monitoring, by the base station, for a third UE, a third radio signal quality parameter for the DL channel and a transmit power for the UL channel of the wireless frequency band; and
based on at least the third radio signal quality parameter meeting the first radio signal quality performance condition but not meeting the second radio signal quality performance condition:
assigning a third set of RBs to the third UE for transmission, wherein transmitting the third set of RBs in the UL channel of the wireless frequency band generates a third relative level of interference in the DL channel of the wireless frequency band, wherein the third set of RBs differs from both the first set of RBs and the second set of RBs, and wherein the third relative level of interference is lower than the first relative level of interference and higher than the second relative level of interference.

17. The one or more computer storage devices of claim 16,
wherein the UL channel of the wireless frequency band is at a higher or lower frequency than the DL channel of the wireless frequency band;
wherein the first set of RBs are at frequencies in the UL channel which are closer to the DL channel of the wireless frequency band than are the second set of RBs; and
wherein the second set of RBs are at frequencies in the UL channel which are closer to the DL channel of the wireless frequency band than are the third set of RBs.

18. The one or more computer storage devices of claim 15, wherein the first radio signal quality parameter and the second radio signal quality parameter each comprises at least one parameter selected from the list consisting of:
DL block error rate (BLER), channel state information (CSI), received signal strength indicator (RSSI), reference signal receive power (RSRP), reference signal received quality (RSRQ), and signal to interference plus noise ratio (SINR).

19. The one or more computer storage devices of claim 15, wherein the second set of RBs is limited by a first maximum number of RBs.

20. The one or more computer storage devices of claim 19, wherein the operations further comprise:
based on at least determining that a transmit power of the second UE meets a transmit power threshold, limiting the second set of RBs to a second maximum number of RBs lower than the first maximum number of RBs.
